(19) United States
(12) Patent Application Publication
(10) Pub. No.: US 2004/0085874 A1
(43) Pub. Date: May 6, 2004

(54) Optical information recording medium, optical recording and reproducing method and optical recording and reproducing apparatus

(75) Inventors: Tetsuya Akiyama, Hirakata-shi (JP); Kenichi Nishiuchi, Hirakata-shi (JP); Naoyasu Miyagawa, Kawanishi-shi (JP)

Correspondence Address: MERCHANT & GOULD PC, P.O. BOX 2903, MINNEAPOLIS, MN, 55402-0903, US

(73) Assignee: MATSUSHITA ELECTRIC INDUSTRIAL CO., LTD., Kadoma-shi (JP)

(21) Appl. No.: 10/692,936

(22) Filed: Oct. 24, 2003

(30) Foreign Application Priority Data
Oct. 28, 2002 (JP) 2002-312436

(51) Int. Cl. G11B 7/00

(52) U.S. Cl. 369/47.53; 369/94; 369/59.11; 369/284

(57) ABSTRACT

An optical information recording medium of the present invention includes first to Nth recording layers (where N is an integer equal to or larger than 2) arranged sequentially from an opposite side of an incident side of a laser beam. The laser beam that has entered from one side is irradiated onto any one of the first to Nth recording layers, thereby recording and reproducing information. At least any one of the first to Nth recording layers includes a correction information recording portion. The correction information recording portion contains a correction information for correcting a laser beam intensity based on a change in a transmittance of the second to Nth recording layers between an unrecorded state and a recorded state.

### BACKGROUND OF THE INVENTION

1. Field of the Invention

The present invention relates to an optical information recording medium including a plurality of recording layers with respect to which information can be recorded and reproduced by irradiation of a laser beam or the like, an optical recording and reproducing method and an optical recording and reproducing apparatus for recording information on and reproducing information from such an optical information recording medium.

2. Description of Related Art

Optical information recording media are known as a large-capacity and high-density memory. Among them, there are rewritable optical information recording media allowing information rewriting, one of which is an optical information recording medium having a thin film as a recording layer on a substrate. The phase of the recording layer reversibly changes between an amorphous state and a crystalline state. Such an optical information recording medium records and erases information by utilizing a phenomenon that thermal energy generated by a laser beam irradiation onto the recording layer causes a reversible phase change in the recording layer between a crystalline phase and an amorphous phase.

As a phase-change material for the recording layer, an alloy film containing at least one element of Ge, Sb, Te and In as a principal component, for example, a Ge—Sb—Te alloy film is known. Information is recorded by changing a part of the recording layer into the amorphous phase so as to form a recording mark. Information is erased by changing the recording mark (the amorphous phase) into the crystalline phase. Such an amorphous phase is achieved by heating the recording layer to a temperature equal to or higher than a melting point and then cooling it down rapidly. On the other hand, the crystalline phase is achieved by heating the recording layer to a temperature equal to or higher than a crystallization temperature and not higher than the melting point and then cooling it down gradually.

Further, a surface of the substrate generally is provided in advance with spiral or concentric guide grooves for laser beam tracking at the time of recording and reproducing. A region between adjacent grooves is called a land. In many cases, one of the groove and the land serves as an information track for recording information, while the other serves as a guard band for separating adjacent information tracks. This is adopted also in recordable CDs (CD-Rs) and Mini Disks (MDs).

For recording information on the optical information recording medium, there is a mark edge recording system in which marks with various lengths are formed leaving various spaces therebetween so that the length of the recording mark and the length of the space (in other words, a front edge position and a back edge position of the recording mark) contain information.

In such a PWM (Pulse Width Modulation) recording system, if a pulse condition such as a laser beam intensity or a pulse generation timing is inappropriate at the time of recording, heat generated in the front of the recording mark enhances a temperature rise in the back, so that a distorted mark is formed whose front part is narrower than the back part, or heat generated when forming a recording mark affects the formation of the adjacent recording mark, so that the edge position of the mark varies. As a result, there arises a problem of reduced signal quality.

In order to solve such a problem, it is important to determine an optimal pulse condition. The optimal pulse condition greatly depends on the characteristics of the optical information recording medium and the optical recording and reproducing apparatus. Thus, every time the optical information recording medium is mounted on the optical recording and reproducing apparatus and the apparatus is activated for recording, it is necessary to conduct a learning operation for determining the optimal pulse condition. The learning operation includes carrying out a test recording while changing a pulse condition, measuring the quality of a reproduced signal of information recorded in the test recording and comparing this measurement result with a predetermined condition, thus obtaining an optimal recording and reproducing condition.

FIG. 8 illustrates an example of a conventional optical information recording medium. As shown in FIG. 8, the center of a disc-shaped optical information recording medium 81 is provided with a center hole 82 for being mounted on an optical recording and reproducing apparatus. The optical information recording medium 81 is formed by providing a recording layer on a 1.1 mm thick transparent substrate formed of polycarbonate with a 0.1 mm thick protective layer further thereon. A laser beam that is irradiated from the side of this protective layer and then passed through the protective layer is irradiated onto the recording layer, thus recording and reproducing information. The transparent substrate is provided with a track 86 for tracking the laser beam at the time of recording and reproducing. Further, the optical information recording medium 81 has a lead-in region 83 exclusively for reproduction in which identification information of the medium is recorded by embossed pits or the like, a test recording region 84 for performing the learning operation for determining the optimal pulse condition, and an information recording region 85 for recording user data.

Furthermore, a recent improvement in processing performance of various kinds of information-processing equipment has increased the amount of information that is handled. Accordingly, there has been a demand for optical information recording media with a larger capacity and a higher-speed recording and reproducing capability. For increasing the capacity, a multilayer recording medium including a plurality of layered recording layers has been suggested, for example, in which information can be recorded in and reproduced from each of the recording layers from one side. In such a multilayer recording medium, each recording layer has different recording and reproducing characteristics such as the optimal laser beam intensity at the time of recording. Therefore, the conventional optical information recording and reproducing apparatus has conducted the learning operation for each recording layer in the optical information recording medium (for example, see JP 11(1999)-3550 A).

In the multilayer recording medium, information is recorded in and reproduced from the recording layers, except for the recording layer provided closest to the incident side of the laser beam, by the laser beam being transmitted by the recording layers provided on the laser beam incident side. Since the transmittance of the recording layer is different depending on whether it is in the amorphous state or the crystalline state, the laser beam transmittance of each recording layer is different depending on whether information is recorded.

For the above reason, the intensity of the laser beam reaching a target recording layer (with respect to which information is recorded and reproduced) varies depending on a recording state of the other recording layers provided closer to the laser beam incident side. Consequently, when information is recorded and reproduced under the pulse condition that is determined by the learning operation according to the conventional manner, there has been a problem that the user data cannot be recorded and reproduced properly.

Moreover, in the learning operation, since the intensity of the laser beam reaching the target recording layer with which an actual learning operation is carried out at the time of test recording varies depending on the recording state of the recording layers provided on the laser beam incident side, there has been a problem that a correct pulse condition cannot be obtained.

### SUMMARY OF THE INVENTION

An optical information recording medium according to the present invention includes first to Nth recording layers (where N is an integer equal to or larger than 2) arranged sequentially from an opposite side of an incident side of a laser beam. The laser beam that has entered from one side is irradiated onto any one of the first to Nth recording layers, thereby recording and reproducing information. At least any one of the first to Nth recording layers includes a correction information recording portion. The correction information recording portion contains a correction information for correcting a laser beam intensity based on a change in a transmittance of the second to Nth recording layers between an unrecorded state and a recorded state.

A first optical recording and reproducing method according to the present invention is an optical recording and reproducing method for recording information on and reproducing information from an optical information recording medium including first to Nth recording layers (where N is an integer equal to or larger than 2) arranged sequentially from an opposite side of an incident side of a laser beam. At least any one of the first to Nth recording layers includes a correction information recording portion. The correction information recording portion contains a correction information for correcting a laser beam intensity based on a change in a transmittance of the second to Nth recording layers between an unrecorded state and a recorded state. When recording the information in and reproducing the information from a Kth recording layer (where K is any integer satisfying 1≦K≦N−1), a pulse condition including a laser beam intensity is determined using the correction information.

A second optical recording and reproducing method according to the present invention is an optical recording and reproducing method for recording information on and reproducing information from an optical information recording medium including first to Nth recording layers (where N is an integer equal to or larger than 2) arranged sequentially from an opposite side of an incident side of a laser beam, by irradiating the laser beam from one side. The method includes setting in advance an order of the first to Nth recording layers in which user data are recorded, recording a recorded recording layer information for specifying the recording layer in which the user data already are recorded at a predetermined position in the optical information recording medium, reading out the recorded recording layer information before recording new user data, and recording the new user data in the recording layers in the order later than the recording layer corresponding to the recorded recording layer information according to the preset order.

An optical recording and reproducing apparatus according to the present invention is an optical recording and reproducing apparatus for recording information on and reproducing information from an optical information recording medium including first to Nth recording layers (where N is an integer equal to or larger than 2) arranged sequentially from an opposite side of an incident side of a laser beam. At least any one of the first to Nth recording layers includes a correction information recording portion. The correction information recording portion contains a correction information for correcting a laser beam intensity based on a change in a transmittance of the second to Nth recording layers between an unrecorded state and a recorded state. The optical recording and reproducing apparatus includes a correction information storing portion for storing the correction information recorded in the optical information recording medium, a control portion for determining a pulse condition for recording user data using the correction information stored in the correction information storing portion, and a pulse condition setting portion for controlling the laser beam using the pulse condition determined in the control portion.

### BRIEF DESCRIPTION OF THE DRAWINGS

FIG. 1 is a sectional view showing an embodiment of an optical information recording medium of the present invention.

FIG. 2 is a sectional view more specifically showing the optical information recording medium shown in FIG. 1.

FIG. 3 shows the relationship between a laser beam intensity at the time of test recording and a jitter value of a reproduced signal.

FIG. 4 shows the relationship between a laser beam intensity at the time of test recording and a jitter value of a reproduced signal.

FIG. 5 is a sectional view showing another embodiment of the optical information recording medium of the present invention.

FIG. 6 is a block diagram showing an embodiment of an optical recording and reproducing apparatus of the present invention.

FIG. 7 is a flowchart showing an optical recording and reproducing method using the optical recording and reproducing apparatus of FIG. 6.

FIG. 8 is a perspective view showing a conventional optical information recording medium.

### DESCRIPTION OF THE PREFERRED EMBODIMENTS

In accordance with an optical information recording medium of the present invention, by using correction information, it is possible to record user data properly regardless of a recording state of each recording layer.

In the optical information recording medium of the present invention, at least any one of the first to Nth recording layers includes a lead-in region exclusively for reproduction, and the correction information recording portion may be provided in the lead-in region.

When the optical information recording medium of the present invention has a disc shape, the first to Nth recording layers in the optical information recording medium of the present invention preferably include at least a test recording region for performing a test recording and an information recording region for recording user data, and the test recording region of a Kth recording layer (where K is any integer satisfying 1≦K≦N−1) preferably is arranged at a radial position different from the test recording region and the information recording region of the (K+1)th to Nth recording layers. This is because a proper pulse condition can be determined by the test recording regardless of the recording state of each of the recording layers. Also, in this case, the first to Nth recording layers may be provided with guide grooves for tracking of the laser beam, and in the (K+1)th to Nth recording layers, guide grooves having substantially the same shape as those of the information recording region may be provided at the radial position where the test recording region of the Kth recording layer is arranged. This is because, since the influence of laser beam diffraction by the guide grooves at the time of test recording becomes equivalent to that in the information recording region, the pulse condition determined in the test recording region can be matched more accurately with the optimal condition in the information recording region.

In the optical information recording medium of the present invention, the correction information may be a correction coefficient determined by a transmittance T1 in the unrecorded state and a transmittance T2 in the recorded state in the second to Nth recording layers. Also, the correction information may be a correction coefficient, and the correction coefficient may be set so that a quality of a reproduced signal of information recorded in a Kth recording layer (where K is any integer satisfying 1≦K≦N−1) using a corrected laser beam corrected with the correction coefficient satisfies a predetermined criterion in the case where at least any one of the (K+1)th to Nth recording layers arranged closer to the laser beam incident side with respect to the Kth recording layer is in the unrecorded state. Further, the correction information may be a transmittance variation information of each of the second to Nth recording layers, for indicating whether the transmittance lowers or rises by recording the information.

In the optical information recording medium of the present invention, the correction information recording portion further may contain a target recording layer information for specifying a recording layer in which user data are to be recorded using the laser beam corrected with the correction information, in addition to the correction information. Moreover, the correction information recording portion further may contain a recording layer specifying information for specifying any of the recording layers arranged closer to the laser beam incident side with respect to the target recording layer, in addition to the correction information and the target recording layer information.

In the optical information recording medium of the present invention, the first to Nth recording layers may include an information recording region for recording user data, at least one of which may include a recorded recording layer information recording portion containing a recorded recording layer information indicating the recording layer having the information recording region in which the user data already are recorded. Furthermore, the recorded recording layer information may include a recorded address information for specifying a position of a recorded region. This also makes it possible to change the laser beam intensity according to the recording state of each recording layer.

In accordance with a first optical recording and reproducing method of the present invention, it is possible to record user data properly on the optical information recording medium of the present invention regardless of a recording state of each of the recording layers.

In the optical recording and reproducing method of the present invention, it is preferable that the optical information recording medium has a disc shape, the first to Nth recording layers include a test recording region for performing at least a test recording and an information recording region for recording user data, and the test recording region of the Kth recording layer is arranged at a radial position different from the test recording region and the information recording region of the (K+1)th to Nth recording layers. When recording the information in the Kth recording layer, the test recording preferably is performed in the test recording region in the Kth recording layer, and a result of the test recording and the correction information preferably are used to determine the pulse condition including the laser beam intensity. This is because a proper pulse condition can be determined by the test recording regardless of the recording state of each of the recording layers.

In the first optical recording and reproducing method of the present invention, the correction information may be a correction coefficient, and the correction coefficient may be set so that a quality of a reproduced signal of the information recorded in the Kth recording layer using a corrected laser beam corrected with the correction coefficient satisfies a predetermined criterion in the case where at least any one of the (K+1)th to Nth recording layers arranged closer to the laser beam incident side with respect to the Kth recording layer is in the unrecorded state. When recording the information in the Kth recording layer, the pulse condition including the laser beam intensity may be determined using the correction coefficient. The quality of the reproduced signal can be evaluated by measuring a jitter value of the reproduced signal. Also, the correction information may be a transmittance variation information of each of the second to Nth recording layers, for indicating whether the transmittance lowers or rises by recording the information. When recording the information in the Kth recording layer, the laser beam intensity may be changed according to the transmittance variation information.

In the first optical recording and reproducing method of the present invention, the optical information recording medium may include the correction information recording portion further containing, in addition to the correction information, a target recording layer information for specifying a recording layer in which user data are to be recorded using the laser beam corrected with the correction information and a recording layer specifying information for specifying any of the recording layers arranged closer to the laser beam incident side with respect to the target recording layer. The correction information includes a plurality of correction coefficients. A recorded recording layer information recording portion provided in at least one of information recording regions in the first to Nth recording layers contains a recorded recording layer information indicating the recording layer having an information recording region in which the user data already are recorded. When recording the information in the Kth recording layer, the target recording layer information corresponding to the Kth recording layer is read out, the correction coefficient recorded together with the recording layer specifying information corresponding to the recorded recording layer information among the recording layer specifying information recorded together with the read-out target recording layer information is selected from the plurality of correction coefficients, and the pulse condition including the laser beam intensity is determined using the selected correction coefficient. More specifically, for example, whether the information already is recorded in each of the recording layers arranged on the laser beam incident side with respect to the target recording layer is judged by the recorded recording layer information, and the correction coefficient is selected according to the recorded recording layer. Furthermore, the recorded recording layer information may include a recorded address information for specifying a position of a recorded region, and the recorded address information further is used when selecting the correction coefficient. This also makes it possible to change the laser beam intensity according to the recording state of each recording layer.

In accordance with a second optical recording and reproducing method of the present invention, it is easy to record user data accurately on a write-once-type optical information recording medium. In this case, the recorded recording layer information also may include the recorded address information for specifying the position of the recorded region.

In accordance with an optical recording and reproducing apparatus of the present invention, it is possible to record user data properly on the optical information recording medium of the present invention regardless of a recording state of each of the recording layers.

In the optical recording and reproducing apparatus of the present invention, it is preferable that the optical information recording medium has a disc shape, the first to Nth recording layers include a test recording region for performing at least a test recording and an information recording region for recording user data, and the test recording region of a Kth recording layer (where K is any integer satisfying 1≦K≦N−1) is arranged at a radial position different from the test recording region and the information recording region of the (K+1)th to Nth recording layers. The optical recording and reproducing apparatus preferably further includes a signal quality judging portion for judging a quality of a reproduced signal of the test-recorded information, and the control portion determines a pulse condition for recording the user data using the correction information and a result of the test recording. This is because a proper pulse condition can be determined by the test recording regardless of the recording state of each of the recording layers.

In the optical recording and reproducing apparatus of the present invention, the optical information recording medium may include the correction information recording portion further containing, in addition to the correction information, a target recording layer information for specifying a recording layer in which user data are to be recorded using the laser beam corrected with the correction information and a recording layer specifying information for specifying any of the recording layers arranged closer to the laser beam incident side with respect to the target recording layer. A recorded recording layer information recording portion provided in at least one of information recording regions in the first to Nth recording layers contains a recorded recording layer information indicating the recording layer having an information recording region in which the user data already are recorded. The optical recording and reproducing apparatus further may include a recorded recording layer information storing portion for storing the recorded recording layer information recorded in the optical information recording medium, and the control portion determines the pulse condition for recording the user data using the correction information and the recorded recording layer information. For example, the correction information may include a plurality of correction coefficients, and when recording the information in a Kth recording layer (where K is any integer satisfying 1≦K<N−1), the control portion may read out the target recording layer information corresponding to the Kth recording layer, select from the plurality of correction coefficients the correction coefficient recorded together with the recording layer specifying information corresponding to the recorded recording layer information among the recording layer specifying information recorded together with the read out target recording layer information and determine the pulse condition for recording the user data using the selected correction coefficient. More specifically, for example, the control portion judges by the recorded recording layer information whether the information already is recorded in each of the recording layers arranged on the laser beam incident side with respect to the target recording layer and selects the correction coefficient according to the recorded recording layer.

In the optical recording and reproducing apparatus of the present invention, the recorded recording layer information may include a recorded address information for specifying a position of a recorded region, and the control portion further may use the recorded address information when selecting the correction coefficient.

In the optical recording and reproducing apparatus of the present invention, the signal quality judging portion may evaluate the quality of the reproduced signal by measuring a jitter value of the reproduced signal.

In the optical recording and reproducing apparatus of the present invention, the pulse condition may include a laser beam intensity, a pulse duration and a generation timing and be set according to at least any one of a length or a space of recorded marks.

First Embodiment

The following is a description of an embodiment of an optical information recording medium of the present invention.

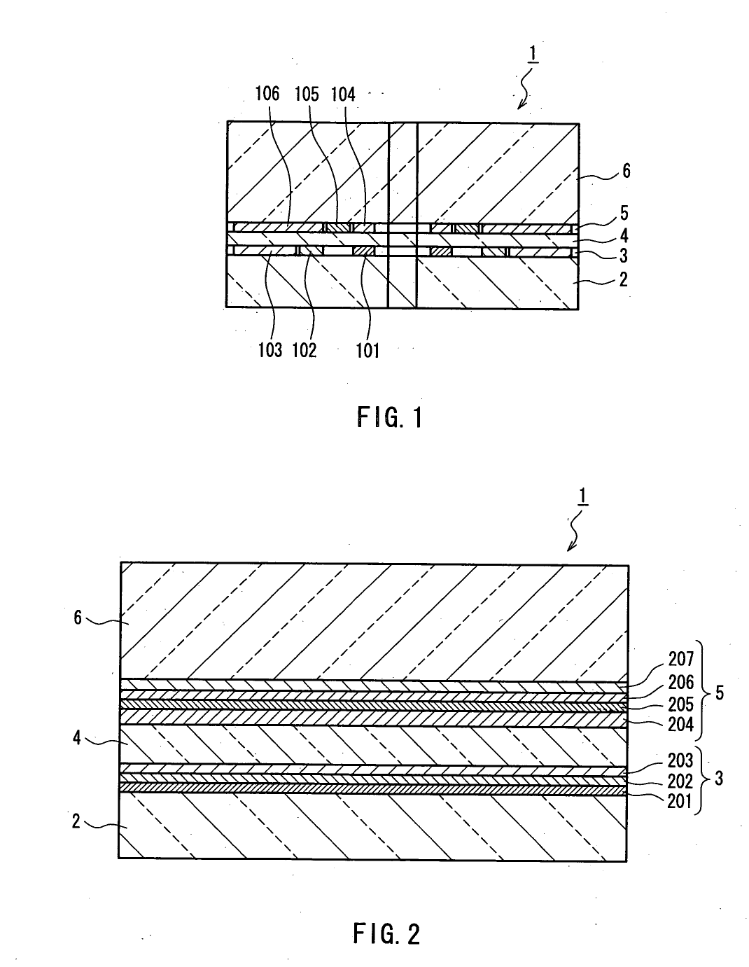

FIG. 1 is a sectional view showing a structure of an optical information recording medium 1 of the present embodiment. The optical information recording medium 1 has a disc shape and includes a first recording layer 5 with a thickness of about 200 nm, a transparent separation layer 4 with a thickness of about 0.03 mm, a second recording layer 3 with a thickness of about 100 nm and a protective film 2 provided in this order on a polycarbonate substrate 6 with a thickness of about 1.1 mm. The first recording layer 5 and the second recording layer 3 are provided with an information track (not shown) with a depth of about 20 nm and a width of about 0.2 μm for tracking a laser beam at the time of recording and reproducing, for example.

In the optical information recording medium 1, the laser beam is irradiated from a surface on the side of the protective layer 2.

The second recording layer 3 has, for example, a lead-in region 101, provided at a radial position from about 22 mm to 23 mm, exclusively for reproduction in which identification information of the medium is recorded by wobbling of the information track, a test recording region 102, provided at a radial position from about 24 mm to 25 mm, for performing a learning operation for determining an optimal pulse condition, and an information recording region 103, provided at a radial position from about 25 mm to 58 mm, for recording user data. The first recording layer 5 has, for example, a lead-in region 104, provided at a radial position from about 22 mm to 23 mm, exclusively for reproduction in which identification information of the medium is recorded by wobbling of the information track, a test recording region 105, provided at a radial position from about 23 mm to 24 mm, for performing a learning operation for determining an optimal pulse condition, and an information recording region 106, provided at a radial position from about 24 mm to 58 mm, for recording user data. In this way, the test recording region 105 of the first recording layer 5 and the test recording region 102 of the second recording layer 3 are provided at different radial positions (no overlap).

FIG. 2 shows a more specific structure of the optical information recording medium 1. As shown in FIG. 2, the second recording layer 3 is formed of a multilayer thin film including, for example, a protective film 201 formed of a dielectric material, a phase change film 202 formed of a Ge—Sb—Te thin film and a protective film 203 formed of a dielectric material. In the present embodiment, the second recording layer 3 is formed of a material whose transmittance decreases when a part of the phase change film 202 changes from a crystalline state to an amorphous state by recording information.

The first recording layer 5 is formed of a multilayer thin film including, for example, a protective film 204 formed of a dielectric material, a phase change film 205 formed of a Ge—Sb—Te thin film, a protective film 206 formed of a dielectric material and a reflective film 207 formed of a metallic material.

In the lead-in region 104 (see FIG. 1) of the first recording layer 5, correction information for correcting a laser beam intensity is recorded. In addition to the correction information, target recording layer information for specifying a recording layer in which user data are to be recorded using a laser beam corrected with that correction information further is recorded in this lead-in region 104. This correction information is, for example, a correction coefficient α for correcting the laser beam intensity drop based on the lowered transmittance of the second recording layer 3 owing to information recording. The lead-in region 104 is provided with a correction information recording portion (not shown) for recording the correction information as described above. For example, the correction coefficient α can be a value represented by the relation below:

α=T1/T2

where T1 is a transmittance of the second recording layer 3 in an unrecorded state and T2 is a transmittance of the second recording layer 3 in a recorded state.

When recording information on and reproducing information from the optical information recording medium 1, the correction coefficient a recorded in the lead-in region 104 of the first recording layer 5 is read out first at the time of activating the optical recording and reproducing apparatus.

Next, the learning operation for determining the optimal pulse condition is performed for each of the first recording layer 5 and the second recording layer 3. More specifically, in the test recording region 105 of the first recording layer 5 and the test recording region 102 of the second recording layer 3, a test recording is carried out while changing the pulse condition such as a laser beam intensity, a pulse duration and a generation timing, and an optimal pulse condition is determined from the result of measuring the quality of a signal obtained by reproducing the recording mark recorded in the test recording.

In the case of recording user data in the information recording region 103 of the second recording layer 3, a laser beam is used according to the pulse condition determined in the test recording region 102. In the case of recording user data in the information recording region 106 of the first recording layer 5, a laser beam is used with an intensity obtained by correcting with the correction coefficient α the optimal laser beam intensity according to the pulse condition determined in the test recording region 105. For example, when P1 is the optimal laser beam intensity according to the pulse condition determined in the test recording region 105, the laser beam intensity for recording the user data on the information recording region 106 is given by P1×α.

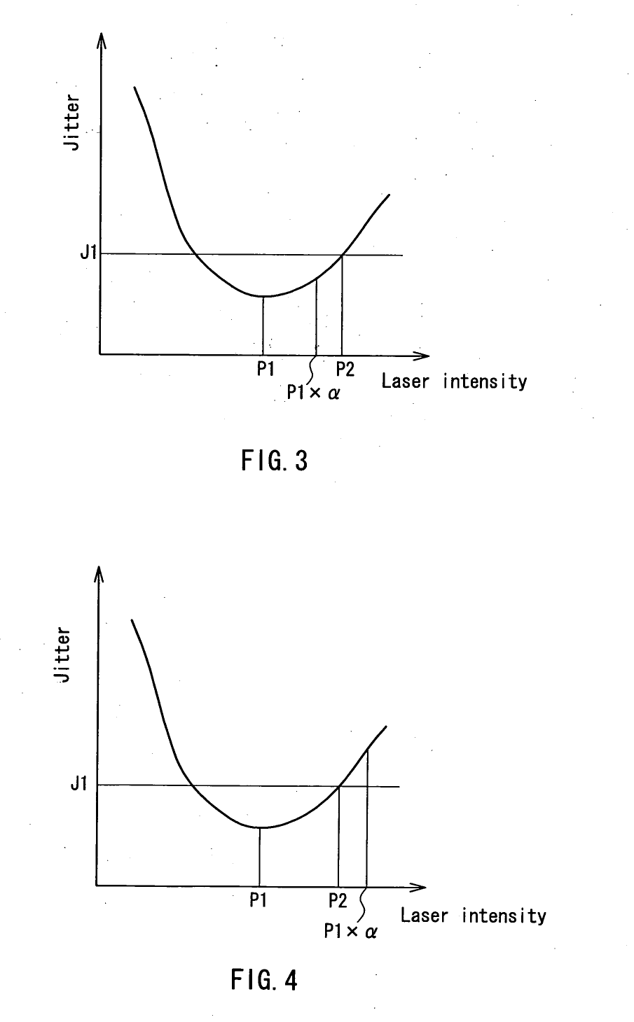

It should be noted that the correction coefficient a is not limited to a value given by α=T1/T2. For example, in the case where the second recording layer 3 is in the unrecorded state (the state in which the transmittance is high), it may be possible to set the correction coefficient a such that the quality of the reproduced signal of the information recorded on the first recording layer 5 using the corrected laser beam with an intensity obtained by correcting the optimal laser beam intensity with the correction coefficient a satisfies a predetermined criterion. For example, in the case where the relationship between the laser beam intensity at the time of test recording and a jitter value of a reproduced signal (the amount that the position of the reproduced signal varies with respect to a reference clock) is as shown in FIG. 3, the correction coefficient a can be set so as to satisfy

P1<P1×α<P2

where P1 is the optimal laser beam intensity when the jitter value is at a minimum and P2 is the maximum laser beam intensity when the jitter value is equal to or lower than a predetermined reference value J1.

For example, at the time of using T1/T2 as the correction coefficient a, when the intensity of the corrected laser beam corrected with the correction coefficient a exceeds the maximum laser beam intensity P2 shown in FIG. 3, it is preferable that the user data are recorded under a pulse condition that the laser beam intensity is near the maximum laser beam intensity P2. In other words, when the relationship between the laser beam intensity obtained by the actual learning operation and the jitter value of the reproduced signal is such that the laser intensity (P1×α) corrected with the correction coefficient a is larger than P2 as shown in FIG. 4, it is preferable that a value near the maximum laser beam intensity P2 is recorded as the correction information, and it is more preferable that the value that is as close as possible to P2 and does not exceed P2 is recorded as the correction information.

Furthermore, in the optical information recording medium 1 of the present embodiment, the second recording layer 3 has a region in which no information is recorded at a radial position corresponding to the test recording region 105 of the first recording layer 5. Thus, at the same radial position as the test recording region 105, no recording is carried out in the second recording layer 3 provided closer to the laser beam incident side, so that the laser beam transmittance always is constant. Accordingly, in the learning operation in the test recording region 105 of the first recording layer 5, a constant pulse condition always can be obtained without any influence by the difference in transmittance of the second recording layer 3 between the recorded state and the unrecorded state.

On the other hand, since the second recording layer 3 is arranged closer to the laser beam irradiation side with respect to the first recording layer 5, it is not influenced by the recording state of the first recording layer 5. Therefore, in the learning operation in the test recording region 102 of the recording layer 3, a constant pulse condition always can be obtained.

Moreover, in the case of recording user data in the information recording region 106 of the first recording layer 5, the laser beam intensity is corrected with the correction coefficient a, thereby compensating for a decrease in a recording sensitivity of the first recording layer 5 owing to the recorded state of the second recording layer 3, allowing a proper recording of the user data. Further, in the case where the correction coefficient a is set so that the quality of the reproduced signal of the information recorded in the first recording layer 5 using a corrected laser beam when the second recording layer 3 is in the unrecorded state satisfies a predetermined criterion, it becomes possible to record and reproduce information more desirably by using the corrected laser beam regardless of whether information is recorded in the second recording layer 3.

Although the lead-in regions are provided in both of the first recording layer 5 and the second recording layer 3 in the present embodiment, they also may be provided in at least one of the first recording layer 5 and the second recording layer 3. In addition, information to be recorded in the lead-in region also may be provided by embossed pits.

Furthermore, the method of the learning operation is not limited to that described above. Instead, it may be possible to adopt a simplified method of carrying out a test recording while changing a recording and reproducing condition, measuring all the time the quality of a signal obtained by reproducing information recorded in the test recording, comparing the result of the measurement with a predetermined condition, and choosing as an optimal pulse condition a pulse condition at the time when the measurement result satisfies the predetermined condition.

Moreover, although the present embodiment has been directed to the case where the information recording lowers the transmittance of the second recording layer 3, a similar effect can be obtained also in the case where the information recording increases the transmittance of the second recording layer 3. However, in that case, if the laser beam intensity under the corrected condition is smaller than the lowest value of the laser beam intensity (a minimum laser beam intensity) at which the quality of the signal reproduced in the learning operation satisfies a certain condition, it is preferable that the user data are recorded according to the pulse condition that the laser beam intensity is near the minimum laser beam intensity. By using the laser beam with an intensity corrected as above, it becomes possible to conduct preferable information recording and reproducing with suppressed signal quality deterioration regardless of whether information is recorded in the second recording layer 3.

Additionally, instead of the correction coefficient a, transmittance variation information for indicating whether the transmittance lowers or rises by recording information in the second recording layer 3 may be recorded on the medium as the correction information. When the correction information is set as above, whether the transmittance lowers or rises by recording information in the second recording layer 3 can be judged by reading out the transmittance variation information. With reference to this transmittance variation information, if the transmittance of the second recording layer 3 is reduced by recording information, then the user data are recorded under the pulse condition that the laser beam intensity is set near the maximum value at which the quality of the signal test-recorded in the first recording layer 5 satisfies a preset criterion, while if the transmittance is increased by recording information, then the user data are recorded under the pulse condition that the laser beam intensity is set near the minimum value at which the quality of the signal test-recorded in the first recording layer 5 satisfies a preset criterion. In this manner, when recording the user data in the information recording region 106 of the first recording layer 5, it is possible to suppress the recording sensitivity drop of the first recording layer 5 owing to the recorded state of the second recording layer 3, thus recording the user data properly.

Although the optical information recording medium including two recording layers has been described in the present embodiment, the structure of the optical information recording medium, the correction information and the optical recording and reproducing method described in the present embodiment also are applicable to an optical information recording medium including three or more recording layers.

Second Embodiment

The following is a description of another embodiment of the optical information recording medium of the present invention.

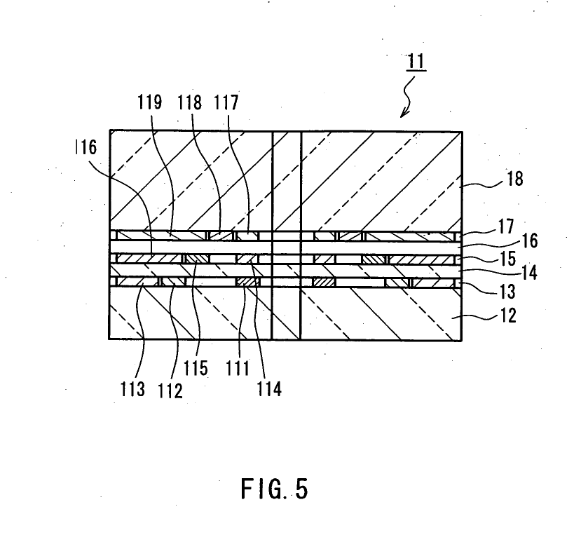

FIG. 5 is a sectional view showing a structure of an optical information recording medium 11 of the present embodiment. The optical information recording medium 11 has a disc shape and includes a first recording layer 17 with a thickness of about 200 nm, a transparent separation layer 16 with a thickness of about 0.02 mm, a second recording layer 15 with a thickness of about 100 nm, a transparent separation layer 14 with a thickness of about 0.02 mm, a third recording layer 13 with a thickness of about 100 nm and a protective film 12 provided in this order on a polycarbonate substrate 18 with a thickness of about 1.1 mm. The first recording layer 17, the second recording layer 15 and the third recording layer 13 are provided with an information track (not shown) with a depth of about 20 nm and a width of about 0.2 μm for tracking a laser beam at the time of recording and reproducing, for example.

In the optical information recording medium 11, the laser beam is irradiated from a surface on the side of the protective layer 12.

The third recording layer 13 has, for example, a lead-in region 111, provided at a radial position from about 22 mm to 23 mm, exclusively for reproduction in which identification information of the medium is recorded by wobbling of the information track, a test recording region 112, provided at a radial position from about 25 mm to 26 mm, for performing a learning operation for determining an optimal pulse condition, and an information recording region 113, provided at a radial position from about 26 mm to 58 mm, for recording user data.

The second recording layer 15 has, for example, a lead-in region 114, provided at a radial position from about 22 mm to 23 mm, exclusively for reproduction in which identification information of the medium is recorded by wobbling of the information track, a test recording region 115, provided at a radial position from about 24 mm to 25 mm, for performing a learning operation for determining an optimal pulse condition, and an information recording region 116, provided at a radial position from about 25 mm to 58 mm, for recording user data.

The first recording layer 17 has, for example, a lead-in region 117, provided at a radial position from about 22 mm to 23 mm, exclusively for reproduction in which identification information of the medium is recorded by wobbling of the information track, a test recording region 118, provided at a radial position from about 23 mm to 24 mm, for performing a learning operation for determining an optimal pulse condition, and an information recording region 119, provided at a radial position from about 24 mm to 58 mm, for recording user data.

The third recording layer 13 and the second recording layer 15 are formed of a multilayer thin film similarly to the second recording layer 3 of the optical information recording medium 1 described in the first embodiment (see FIG. 2) and their transmittance is reduced by recording information in the present embodiment. The recording layer 17 is formed of a multilayer thin film similarly to the first recording layer 5 of the optical information recording medium 1 described in the first embodiment (see FIG. 2).

In the lead-in region 117 of the first recording layer 17, correction information for correcting the laser beam intensity is recorded. In addition to the correction information, target recording layer information for specifying a recording layer in which user data are to be recorded using a laser beam corrected with that correction information further is recorded in this lead-in region 117. In the present embodiment, as the correction information, for example, a correction coefficient α1 for correcting the laser beam intensity based on the lowered transmittance of the second recording layer 15 when information is recorded in the second recording layer 15, a correction coefficient α2 for correcting the laser beam intensity based on the lowered transmittance of the third recording layer 13 when information is recorded in the third recording layer 13 and a correction coefficient α3 for correcting the laser beam intensity based on the lowered transmittance of the second recording layer 15 and the third recording layer 13 when information is recorded in both of the second recording layer 15 and the third recording layer 13 are recorded. The correction coefficients al and α2 respectively are recorded together with recording layer specifying information indicating the second recording layer 15 and the third recording layer 13, and the correction coefficient α3 is recorded together with recording layer specifying information indicating both of the third recording layer 13 and the second recording layer 15.

In the case where the user data are recorded in the optical information recording medium 11, recorded recording layer information indicating the number of a recorded recording layer in which the data are recorded over an entire surface of the information recording region is recorded at, for example, a predetermined position (a recorded recording layer information recording portion) of the information recording region 119 of the first recording layer 17. For example, when the recorded recording layer information is represented by β, β=100 if the data are recorded only in the first recording layer 17, β=110 if the data are recorded in both of the first recording layer 17 and the second recording layer 15, β=010 if the data are recorded only in the second recording layer 15, β=001 if the data are recorded only in the third recording layer 13, β=011 if the data are recorded in both of the second recording layer 15 and the third recording layer 13, and β=111 if the data are recorded in all of the recording layers 17, 15 and 13.

Then, when recording information on the optical information recording medium 11 again, the correction coefficients α1, α2 and α3 recorded in the lead-in region 117 of the first recording layer 17 are read out and at the same time, the recorded recording layer information recorded in the information recording region 119 of the first recording layer 17 is read out at the time of activating the optical recording and reproducing apparatus.

Also, for each of the test recording regions 118, 115 and 112 of the first recording layer 17, the second recording layer 15 and the third recording layer 13, the learning operation is performed including carrying out a test recording while changing the pulse condition, and determining an optimal pulse condition from the result of measuring the quality of a signal recorded in the test recording.

In the case of recording the user data in the information recording region 113 of the third recording layer 13, the data are recorded according to the pulse condition determined in the test recording for the test recording region 112.

In the case of recording the user data in the information recording region 116 of the second recording layer 15, whether data already are recorded in the third recording layer 13 is judged from the recorded recording layer information. If the third recording layer 13 is in the unrecorded state, then the user data are recorded according to the pulse condition determined in the learning operation in the test recording region 115. If the third recording layer 13 is in the recorded state, then the user data are recorded using a corrected laser beam obtained by correcting with the correction coefficient α2 the laser beam intensity according to the pulse condition determined in the learning operation in the test recording region 115.

Further, in the case of recording the user data in the information recording region 119 of the first recording layer 17, whether data already are recorded in the third recording layer 13 and the second recording layer 15 is judged from the recorded recording layer information. If the third recording layer 13 and the second recording layer 15 are both in the unrecorded state, then the user data are recorded according to the pulse condition determined in the learning operation in the test recording region 118. If the third recording layer 13 alone is in the recorded state, then the user data are recorded using a corrected laser beam obtained by correcting with the correction coefficient α2 the laser beam intensity according to the pulse condition determined in the learning operation in the test recording region 118. If the second recording layer 15 alone is in the recorded state, then the user data are recorded using a corrected laser beam obtained by correcting with the correction coefficient α1 the laser beam intensity according to the pulse condition determined in the learning operation in the test recording region 118. If the first recording layer 13 and the second recording layer 15 are both in the recorded state, then the user data are recorded using a corrected laser beam obtained by correcting with the correction coefficient α3 the laser beam intensity according to the pulse condition determined in the learning operation in the test recording region 118.

Furthermore, in the optical information recording medium 11 of the present embodiment, the third recording layer 13 has a region in which no information is recorded at a radial position corresponding to the test recording region 115 of the second recording layer 15. Also, the second recording layer 15 and the third recording layer 13 have a region in which no information is recorded at a radial position corresponding to the test recording region 118 of the first recording layer 17. In this way, at the radial positions corresponding to the test recording regions 115 and 118, no information is recorded in the recording layers provided closer to the laser beam incident side. Accordingly, in the learning operation in the test recording regions 115 and 118, a constant pulse condition always can be obtained because there is no influence by the difference in transmittance due to the recorded or unrecorded state of the recording layer positioned closer to the laser beam incident side.

In the case of recording the user data in the information recording region 116 of the second recording layer 15 and the information recording region 119 of the first recording layer 17, a correction coefficient corresponding to the recorded recording layer information is selected from the correction coefficients α1, α2 and α3, thereby compensating for a decrease in a recording sensitivity of the second recording layer 15 and the first recording layer 17 owing to the information recording in the third recording layer 13 and the second recording layer 15, allowing a proper recording of the user data.

It should be noted that the correction coefficients α1, α2 and α3 in the present embodiment can be set similarly to the correction coefficient α described in the first embodiment.

Furthermore, although the lead-in regions are provided in all the recording layers 13, 15 and 17 in the present embodiment, they also may be provided in at least one of the recording layers. In addition, information in the lead-in region also may be provided by embossed pits.

Moreover, although three recording layers are provided in the present embodiment, a similar effect can be achieved in the case of providing two recording layers or four or more recording layers.

Third Embodiment

The following is a description of an embodiment of an optical recording and reproducing apparatus of the present invention.

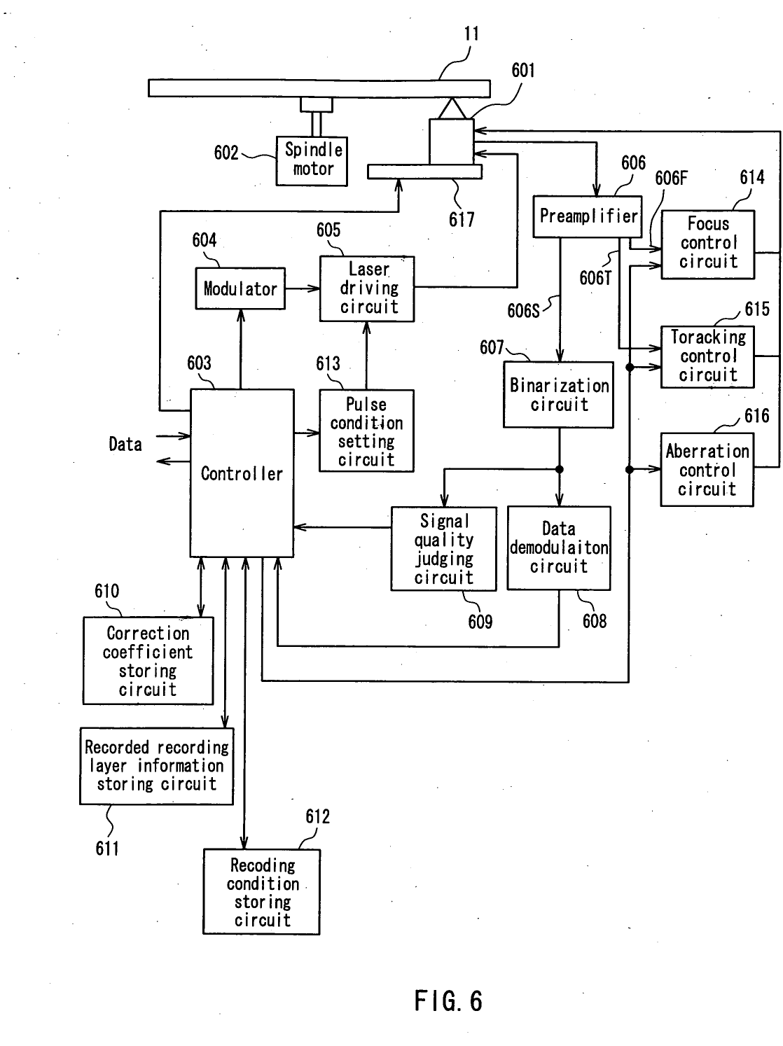

FIG. 6 is a block diagram showing a configuration of the optical recording and reproducing apparatus in the present embodiment and illustrates the state in which the optical information recording medium 11 having a plurality of recording layers shown in FIG. 5 is mounted.

The optical recording and reproducing apparatus shown in FIG. 6 includes a spindle motor 602, a controller (a control portion) 603, a modulator 604, a laser driving circuit 605, an optical head 601, a preamplifier 606, a binarization circuit 607, a data demodulation circuit 608, a signal quality judging circuit (a signal quality judging portion) 609, a recording condition storing circuit 612, a correction coefficient storing circuit (a correction coefficient storing portion) 610, a recorded recording layer information storing circuit (a recorded recording layer information storing portion) 611, a pulse condition setting circuit (a pulse condition setting portion) 613, a focus control circuit 614, a tracking control circuit 615, an aberration control circuit 616 and a moving member 617. The spindle motor 602 rotates the mounted optical information recording medium 11. The modulator 604 converts data to be recorded into a recording signal. The laser driving circuit 605 drives a semiconductor laser according to the recording signal from the modulator 604. The optical head 601 is provided with the semiconductor laser and focuses a laser beam onto the optical information recording medium 11 to record information and obtain a reproduced signal from a reflected light beam. The preamplifier 606 amplifies the reproduced signal and generates an information reproduced signal 606S, a focus error signal 606F and a tracking error signal 606T. The binarization circuit 607 converts the information reproduced signal 606S into a binary signal. The data demodulation circuit 608 demodulates data from the binary signal. The signal quality judging circuit 609 judges the quality of a signal for specific data recorded and reproduced for testing in a test recording region of the optical information recording medium 11. The recording condition storing circuit 612 stores an optimal recording condition obtained in the learning operation. The correction coefficient storing circuit 610 stores the correction coefficient α1, α2 and α3, read out from the optical information recording medium 11, for correcting a laser beam intensity. The recorded recording layer information storing circuit 611 stores recorded recording layer information read out from the optical information recording medium 11. The pulse condition setting circuit 613 controls a laser beam intensity according to the optimal recording condition, the recorded recording layer information and the correction coefficients α1, α2 and α3. The focus control circuit 614 controls the optical head 601 based on the focus error signal 606F so as to focus a laser beam onto a target recording layer in the optical information recording medium 11. The tracking control circuit 615 controls the optical head 601 based on the tracking error signal 606T so that the laser beam properly scans a track on the optical information recording medium 11. The aberration control circuit 616 controls the optical head 601 so that an aberration of the laser beam on the target recording layer is at a minimum. Further, the moving member 617 moves the optical head 601 in a radial direction of the optical information recording medium 11.

The focus error signal 606F is generated by a general method called an astigmatic method. The tracking error signal 606T is generated by a general method called a push-pull method.

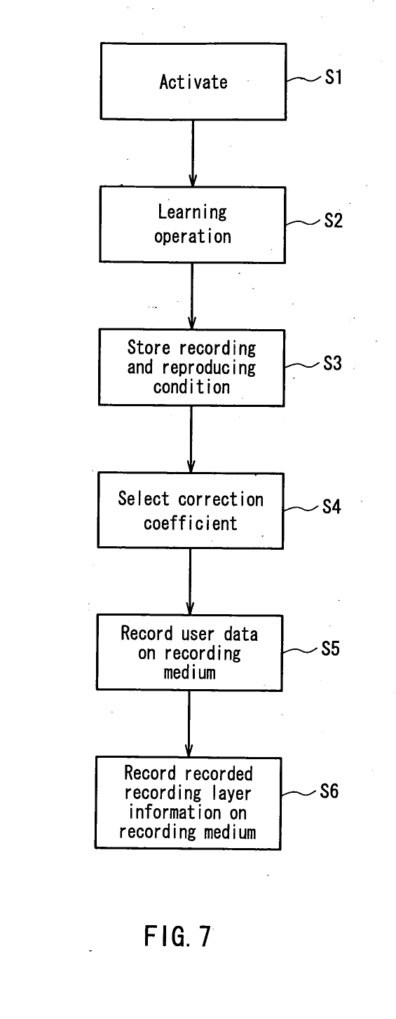

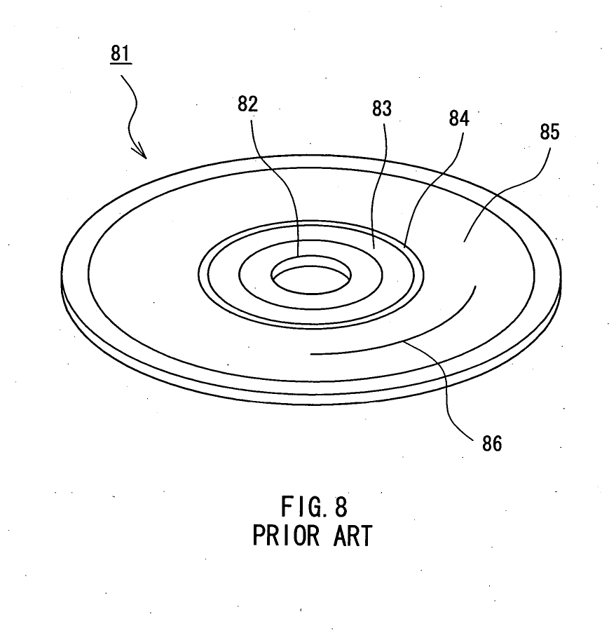

FIG. 7 is a flowchart showing an optical recording and reproducing method using the optical recording and reproducing apparatus in FIG. 6. In the following, the optical recording and reproducing method of the present embodiment will be described, with reference to FIG. 7, FIG. 5 and FIG. 6.

First, the optical recording and reproducing apparatus is activated (Step (in the following, Step will be abbreviated as S) 1). More specifically, the optical information recording medium 11 is mounted and rotated on the spindle motor 602, and then a laser beam for reproducing information is irradiated onto the optical information recording medium 11 by the optical head 601. For example, the laser beam is focused onto the first recording layer 17 arranged farthest from the laser beam incident side, thus accessing the lead-in region 117, performing tracking of an information track, and reading out identification information and a correction coefficient of the optical information recording medium 11. Furthermore, a predetermined region of the information recording region 119 is accessed, thereby reading out the recorded recording layer information. The identification information is read out as follows. The information reproduced signal 606S obtained in the optical head 601 from the light beam reflected by the optical information recording medium 11 is processed into a binary signal in the binarization circuit 607, and this binary signal is demodulated in the data demodulation circuit 608 and then taken in the controller 603. The recorded recording layer information and the correction coefficients α1, α2 and α3 respectively are stored in the recorded recording layer information storing circuit 611 and the correction coefficient storing circuit 610.

Next, the learning operation for determining the optimal recording and reproducing condition is carried out (S2). The learning operation is carried out by following the processes below. Specifically, the optical head 601 first is moved to access the test recording region 118 of the first recording layer 17. The controller 603 sets the pulse condition setting circuit 613 to a preset specific condition or a condition designated by the identification information. Next, the modulator 604 converts the specific data for learning operation outputted from the controller 603 into the laser driving signal. The laser driving circuit 605 drives the semiconductor laser provided in the optical head 601 according to this laser driving signal. The optical head 601 focuses the light emitted from the semiconductor laser onto the optical information recording medium 11, thus recording a test signal in the test recording region 118. The signal quality judging circuit 609 measures a jitter value of a reproduced signal of the test-recorded data and compares it with a preset criterion so as to judge the signal quality. If the jitter value of the reproduced signal of the test-recorded data satisfies the criterion, the signal quality judging circuit 609 sends the result of learning to the controller 603 and ends the learning operation. If the jitter value does not satisfy the criterion, the signal quality judging circuit 609 performs the test recording of specific data and judges the signal quality of the test-recorded data while sequentially changing the pulse condition. By repeating this process until the jitter value satisfies the criterion, the optimal recording condition is determined. For the second recording layer 15 and the third recording layer 13, the optimal recording condition also is determined in similar processes.

Then, the optimal recording condition obtained in the learning operation in S2 is stored in the recording and reproducing condition storing circuit 612 (S3).

Subsequently, based on the target recording layer information specifying the recording layer in which the user data are to be recorded and the recorded recording layer information, a corresponding correction coefficient is selected from the correction coefficients (S4).

In the case where the user data are to be recorded in the first recording layer 17 and the correction coefficient α1 determined based on the lowered transmittance of the second recording layer 15 when information is recorded in the second recording layer 15, the correction coefficient α2 determined based on the lowered transmittance of the third recording layer 13 when information is recorded in the third recording layer 13 and the correction coefficient α3 determined based on the combined lowered transmittance of the third recording layer 13 and the second recording layer 15 when information is recorded in both of the third recording layer 13 and the second recording layer 15 are read out from the optical information recording medium 11 in S1, the correction coefficient is selected in the following manner, for example. Whether information is already recorded in the third recording layer 13 and the second recording layer 15 is judged from the recorded recording layer information. If the third recording layer 13 and the second recording layer 15 are both in the unrecorded state, no correction coefficient is used. If the third recording layer 13 alone is in the recorded state, the correction coefficient α2 is selected. If the second recording layer 15 alone is in the recorded state, the correction coefficient al is selected. If the third recording layer 13 and the second recording layer 15 are both in the recorded state, the correction coefficient α3 is selected.

Next, the pulse condition is set based on the optimal recording condition and the correction coefficient, and the user data are recorded in the information recording region (S5).

The pulse condition includes the laser beam intensity, the pulse duration and the generation timing and is set according to the length and space of the marks to be recorded.

Furthermore, the latest recorded recording layer information is recorded in a predetermined region in the information recording region 119 of the optical information recording medium 11 (S6).

In this manner, the drop of the recording sensitivity of the second recording layer 15 and the first recording layer 17 caused by recording the user data in the third recording layer 13 and the second recording layer 15 is compensated for by correcting the laser beam intensity using the correction coefficient, making it possible to record the user data properly.

Incidentally, recorded address information specifying the position of the recorded region in which the user data are recorded may be included in the recorded recording layer information. In this case, the recorded address information is read out before recording new user data, and the correction coefficient can be selected based on the position of the recorded region and the position in which the user data are to be recorded.

For example, in the case of recording the user data in the first recording layer 17, if it is judged from the recorded address information included in the recorded recording layer information read out in S1 that information is already recorded in the entire region of the second recording layer 15 and midway through the third recording layer 13, then the correction coefficient is selected in S4 as follows. When the radial position at which the information is to be recorded on the first recording layer 17 corresponds to the radial position in a recorded region in the second recording layer 15, the correction coefficient α3 is selected. When it corresponds to the radial position in an unrecorded region in the third recording layer 13, the correction coefficient al is selected.

In this manner, even when information is recorded midway through the recording layer arranged closer to the laser beam incident side, the lowered recording sensitivity caused by recording the user data in the recording layer closer to the incident side can be compensated for reliably based on the relationship between the radial position of the recorded region and that in which information is to be recorded.

Furthermore, in the case of a write-once-type optical information recording medium in which recorded user data are never rewritten, it is preferable to set the order of the recording layers in which the user data will be recorded. For example, in the case where information are to be recorded from the farthest recording layer to the recording layers toward the laser beam incident side sequentially, information is recorded in the target recording layer, with no information being recorded in any of the recording layers arranged closer to the laser beam incident side with respect to the target recording layer, so that the user data can be recorded properly according to the pulse condition determined in the learning operation. Also, in the case where information are to be recorded from the closest recording layer to the recording layers away from the laser beam incident side sequentially, since all of the recording layers arranged closer to the laser beam incident side with respect to the target recording layer are in the recorded state, it becomes easier to control the laser beam intensity.

In the case where the order of the recording layers in which the user data will be recorded is set in advance, it also may be possible to record the recorded recording layer information and the recorded address information at a specific position on the optical information recording medium, read out these recorded recording layer information and recorded address information before recording new user data, performing the learning operation only for the recording layers in which the user data are to be recorded in the order later than the recording layer corresponding to the recorded recording layer information, and thus determining the pulse condition for recording the user data. In this case, since the test recording is performed only for the recording layers in which the user data may be recorded, time required for the learning operation can be reduced.

As described above, in accordance with the optical information recording medium of the present invention, the recording and reproducing method and recording and reproducing apparatus therefor, it becomes possible both to determine a proper pulse condition by the learning operation and to record user data properly regardless of the recording state of information in each recording layer.

The invention may be embodied in other specific forms without departing from the spirit or essential characteristics thereof The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

What is claimed is:

1. An optical information recording medium comprising:
first to Nth recording layers (where N is an integer equal to or larger than 2) arranged sequentially from an opposite side of an incident side of a laser beam, the laser beam that has entered from one side being irradiated onto any one of the first to Nth recording layers, thereby recording and reproducing information;
wherein at least any one of the first to Nth recording layers comprises a correction information recording portion, the correction information recording portion containing a correction information for correcting a laser beam intensity based on a change in a transmittance of the second to Nth recording layers between an unrecorded state and a recorded state.

2. The optical information recording medium according to claim 1, wherein at least any one of the first to Nth recording layers comprises a lead-in region exclusively for reproduction, and
the correction information recording portion is provided in the lead-in region.

3. The optical information recording medium according to claim 1, wherein the optical information recording medium has a disc shape,
the first to Nth recording layers comprise at least a test recording region for performing a test recording and an information recording region for recording user data, and
the test recording region of a Kth recording layer (where K is any integer satisfying 1≦K≦N−1) is arranged at a radial position different from the test recording region and the information recording region of the (K+1)th to Nth recording layers.

4. The optical information recording medium according to claim 3, wherein the first to Nth recording layers are provided with guide grooves for tracking of the laser beam, and
in the (K+1)th to Nth recording layers, guide grooves having substantially the same shape as those of the information recording region are provided at the radial position where the test recording region of the Kth recording layer is arranged.

5. The optical information recording medium according to claim 1, wherein the correction information is a correction coefficient determined by a transmittance T1 in the unrecorded state and a transmittance T2 in the recorded state in the second to Nth recording layers.

6. The optical information recording medium according to claim 1, wherein the correction information is a correction coefficient, and
the correction coefficient is set so that a quality of a reproduced signal of information recorded in a Kth recording layer (where K is any integer satisfying 1≦K≦N−1) using a corrected laser beam corrected with the correction coefficient satisfies a predetermined criterion in the case where at least any one of the (K+1)th to Nth recording layers arranged closer to the laser beam incident side with respect to the Kth recording layer is in the unrecorded state.

7. The optical information recording medium according to claim 1, wherein the correction information is a transmittance variation information of each of the second to Nth recording layers, for indicating whether the transmittance lowers or rises by recording the information.

8. The optical information recording medium according to claim 1, wherein the correction information recording portion further contains a target recording layer information for specifying a recording layer in which user data are to be recorded using the laser beam corrected with the correction information, in addition to the correction information.

9. The optical information recording medium according to claim 8, wherein the correction information recording portion further contains a recording layer specifying information for specifying any of the recording layers arranged closer to the laser beam incident side with respect to the target recording layer, in addition to the correction information and the target recording layer information.

10. The optical information recording medium according to claim 1, wherein the first to Nth recording layers comprise an information recording region for recording user data, at least one of which comprises a recorded recording layer information recording portion containing a recorded recording layer information indicating the recording layer having the information recording region in which the user data already are recorded.

11. The optical information recording medium according to claim 10, wherein the recorded recording layer information comprises a recorded address information for specifying a position of a recorded region.

12. An optical recording and reproducing method for recording information on and reproducing information from an optical information recording medium comprising first to Nth recording layers (where N is an integer equal to or larger than 2) arranged sequentially from an opposite side of an incident side of a laser beam, at least any one of which comprising a correction information recording portion, the correction information recording portion containing a correction information for correcting a laser beam intensity based on a change in a transmittance of the second to Nth recording layers between an unrecorded state and a recorded state;
wherein when recording the information in and reproducing the information from a Kth recording layer (where K is any integer satisfying 1≦K≦N−1), a pulse condition including a laser beam intensity is determined using the correction information.

13. The optical recording and reproducing method according to claim 12, wherein the optical information recording medium has a disc shape, the first to Nth recording layers comprise at least a test recording region for performing a test recording and an information recording region for recording user data, and the test recording region of the Kth recording layer is arranged at a radial position different from the test recording region and the information recording region of the (K+1)th to Nth recording layers, and
when recording the information in the Kth recording layer, the test recording is performed in the test recording region in the Kth recording layer, and a result of the test recording and the correction information are used to determine the pulse condition including the laser beam intensity.

14. The optical recording and reproducing method according to claim 12, wherein the correction information is a correction coefficient, and the correction coefficient is set so that a quality of a reproduced signal of the information recorded in the Kth recording layer using a corrected laser beam corrected with the correction coefficient satisfies a predetermined criterion in the case where at least any one of the (K+1)th to Nth recording layers arranged closer to the laser beam incident side with respect to the Kth recording layer is in the unrecorded state, and
when recording the information in the Kth recording layer, the pulse condition including the laser beam intensity is determined using the correction coefficient.

15. The optical recording and reproducing method according to claim 14, wherein the quality of the reproduced signal is evaluated by measuring a jitter value of the reproduced signal.

16. The optical recording and reproducing method according to claim 12, wherein the correction information is a transmittance variation information of each of the second to Nth recording layers, for indicating whether the transmittance lowers or rises by recording the information, and
when recording the information in the Kth recording layer, the laser beam intensity is changed according to the transmittance variation information.

17. The optical recording and reproducing method according to claim 12, wherein the optical information recording medium comprises the correction information recording portion further containing, in addition to the correction information, a target recording layer information for specifying a recording layer in which user data are to be recorded using the laser beam corrected with the correction information and a recording layer specifying information for specifying any of the recording layers arranged closer to the laser beam incident side with respect to the target recording layer, the correction information comprising a plurality of correction coefficients, and a recorded recording layer information recording portion provided in at least one of information recording regions in the first to Nth recording layers contains a recorded recording layer information indicating the recording layer having an information recording region in which the user data already are recorded, and
when recording the information in the Kth recording layer, the target recording layer information corresponding to the Kth recording layer is read out, the correction coefficient recorded together with the recording layer specifying information corresponding to the recorded recording layer information among the recording layer specifying information recorded together with the read-out target recording layer information is selected from the plurality of correction coefficients, and the pulse condition including the laser beam intensity is determined using the selected correction coefficient.

18. The optical recording and reproducing method according to claim 17, wherein whether the information already is recorded in each of the recording layers arranged on the laser beam incident side with respect to the target recording layer is judged by the recorded recording layer information, and the correction coefficient is selected according to the recorded recording layer.

19. The optical recording and reproducing method according to claim 17, wherein the recorded recording layer information comprises a recorded address information for specifying a position of a recorded region, and the recorded address information further is used when selecting the correction coefficient.

20. An optical recording and reproducing method for recording information on and reproducing information from an optical information recording medium comprising first to Nth recording layers (where N is an integer equal to or larger than 2) arranged sequentially from an opposite side of an incident side of a laser beam, by irradiating the laser beam from one side; the method comprising.
setting in advance an order of the first to Nth recording layers in which user data are recorded;
recording a recorded recording layer information for specifying the recording layer in which the user data already are recorded at a predetermined position in the optical information recording medium;
reading out the recorded recording layer information before recording new user data; and
recording the new user data in the recording layers in the order later than the recording layer corresponding to the recorded recording layer information according to the preset order.

21. The optical recording and reproducing method according to claim 20, wherein the recorded recording layer information comprises a recorded address information for specifying a position of a recorded region.

22. An optical recording and reproducing apparatus for recording information on and reproducing information from an optical information recording medium comprising first to Nth recording layers (where N is an integer equal to or larger than 2) arranged sequentially from an opposite side of an incident side of a laser beam, at least any one of which comprising a correction information recording portion, the correction information recording portion containing a correction information for correcting a laser beam intensity based on a change in a transmittance of the second to Nth recording layers between an unrecorded state and a recorded state;
wherein the optical recording and reproducing apparatus comprises
a correction information storing portion for storing the correction information recorded in the optical information recording medium,
a control portion for determining a pulse condition for recording user data using the correction information stored in the correction information storing portion, and
a pulse condition setting portion for controlling the laser beam using the pulse condition determined in the control portion.

23. The optical recording and reproducing apparatus according to claim 22, wherein the optical information recording medium has a disc shape, the first to Nth recording layers comprise at least a test recording region for performing a test recording and an information recording region for recording user data, and the test recording region of a Kth recording layer (where K is any integer satisfying 1≦K≦N−1) is arranged at a radial position different from the test recording region and the information recording region of the (K+1)th to Nth recording layers, and
the optical recording and reproducing apparatus further comprises a signal quality judging portion for judging a quality of a reproduced signal of the test-recorded information, and the control portion determines a pulse condition for recording the user data using the correction information and a result of the test recording.

24. The optical recording and reproducing apparatus according to claim 22, wherein the optical information recording medium comprises the correction information recording portion further containing, in addition to the correction information, a target recording layer information for specifying a recording layer in which user data are to be recorded using the laser beam corrected with the correction information and a recording layer specifying information for specifying any of the recording layers arranged closer to the laser beam incident side with respect to the target recording layer, and a recorded recording layer information recording portion provided in at least one of information recording regions in the first to Nth recording layers contains a recorded recording layer information indicating the recording layer having an information recording region in which the user data already are recorded, and
the optical recording and reproducing apparatus further comprises a recorded recording layer information storing portion for storing the recorded recording layer information recorded in the optical information recording medium, and the control portion determines the pulse condition for recording the user data using the correction information and the recorded recording layer information.

25. The optical recording and reproducing apparatus according to claim 24, wherein the correction information comprises a plurality of correction coefficients, and
when recording the information in a Kth recording layer (where K is any integer satisfying 1≦K≦N−1), the control portion reads out the target recording layer information corresponding to the Kth recording layer, selects from the plurality of correction coefficients the correction coefficient recorded together with the recording layer specifying information corresponding to the recorded recording layer information among the recording layer specifying information recorded together with the read out target recording layer information and determines the pulse condition for recording the user data using the selected correction coefficient.

26. The optical recording and reproducing apparatus according to claim 25, wherein the control portion judges by the recorded recording layer information whether the information already is recorded in each of the recording layers arranged on the laser beam incident side with respect to the target recording layer and selects the correction coefficient according to the recorded recording layer.

27. The optical recording and reproducing apparatus according to claim 25, wherein the recorded recording layer information comprises a recorded address information for specifying a position of a recorded region, and the control portion further uses the recorded address information when selecting the correction coefficient.

28. The optical recording and reproducing apparatus according to claim 23, wherein the signal quality judging portion evaluates the quality of the reproduced signal by measuring a jitter value of the reproduced signal.

29. The optical recording and reproducing apparatus according to claim 22, wherein the pulse condition includes a laser beam intensity, a pulse duration and a generation timing and is set according to at least any one of a length or a space of recorded marks.
